(19) United States
(12) Patent Application Publication
(10) Pub. No.: US 2006/0107209 A1
(43) Pub. Date: May 18, 2006

(54) Systems and methods for establishing an education web page template

(75) Inventors: Sung-Chieh Chen, Taipei City (TW); Pai-Pin Wang, Kuanhsi Town (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Institute for information Industry

(21) Appl. No.: 11/034,486

(22) Filed: Jan. 13, 2005

(30) Foreign Application Priority Data
Nov. 15, 2004 (TW) 93134883

(51) Int. Cl. G06F 17/24; G06F 17/21; G06F 3/00

(52) U.S. Cl. 715/530; 715/513; 715/769; 715/515

(57) ABSTRACT

A system for establishing education web page templates comprises an element container, template elements, and a template generation module. One of the template elements is added to the element container by dragging. The template generation module creates a format template and a content template based on the element container and the template element therein. The format template comprises a format element corresponding to the template element. The content template comprises a content element corresponding to the template element. The template generation module further integrates the format template and the content template to generate a web page comprising a page element generated by integrating the format element and the content element.

### BACKGROUND

The invention relates to computer networks, and in particular, to systems and methods for establishing education web page templates.

In distance learning or e-learning, courses comprising articles, pictures, and multimedia are provided on web pages. For editing pages, web page authoring expertise is required, in protocols such as Hypertext Markup Language (HTML), JavaScript, Cascading Style Sheet (CSS), and Application Program Interface (API) for communication with a Learning Management System (LMS) . It is time consuming, however, to acquire related web authoring knowledge. Although some web page editing software packages, such as Frontpage and Dreamweaver, are available, they are not dedicated to web pages requiring special teaching and examination user interface.

### SUMMARY

Accordingly, systems and methods for establishing education web page templates are provided. An exemplary embodiment of a system for establishing education web page templates comprises an element container, template elements, and a template generation module. One template element is added to the element container by way of dragging. The template generation module creates a format template and a content template based on the element container and the template element therein. The format template comprises a format element corresponding to the template element. The content template comprises a content element corresponding to the template element. The template generation module further integrates the format template and the content template to generate a web page comprising a page element generated by integrating the format element and the content element.

Additionally, an exemplary embodiment of a system for establishing education web page templates comprises an element container, template elements, and a web page generation module. One template element of the template elements is added to the element container by way of dragging. The web page generation module creates a web page comprising a page element corresponding to the template element based on the element container and the template element therein, wherein the page element communicates with a Learning Management System (LMS).

Additionally, an exemplary embodiment of a method for establishing education web page templates is implemented in a computer comprising an element container, a plurality of template elements, and a template generation module. The template elements and the element container are displayed. One template element of the template elements is added to the element container by way of dragging. The template generation module creates a format template and a content template based on the element container and the template element therein. The format template comprises a format element corresponding to the template element. The content template comprises a content element corresponding to the template element. The template generation module further integrates the format template and the content template to generate a web page comprising a page element generated by integrating the format element and the content element.

### DESCRIPTION OF THE DRAWINGS

The invention can be more fully understood by reading the subsequent detailed description and examples with references made to the accompanying drawings, wherein:

FIG. 1 is a block diagram of an exemplary embodiment of an e-learning system;

FIG. 2 is a block diagram of an exemplary embodiment of a system for establishing education web page templates;

FIG. 3 is a flowchart of an exemplary embodiment of a method for establishing education web page templates;

FIG. 4 is a schematic diagram of an exemplary embodiment of an interface for editing web pages;

FIG. 5 is a schematic diagram of an exemplary embodiment of an element container and layout of template elements therein;

FIG. 6 is a schematic diagram of an exemplary web page layout;

FIG. 7 is a schematic diagram of exemplary layouts of a format template and a content template;

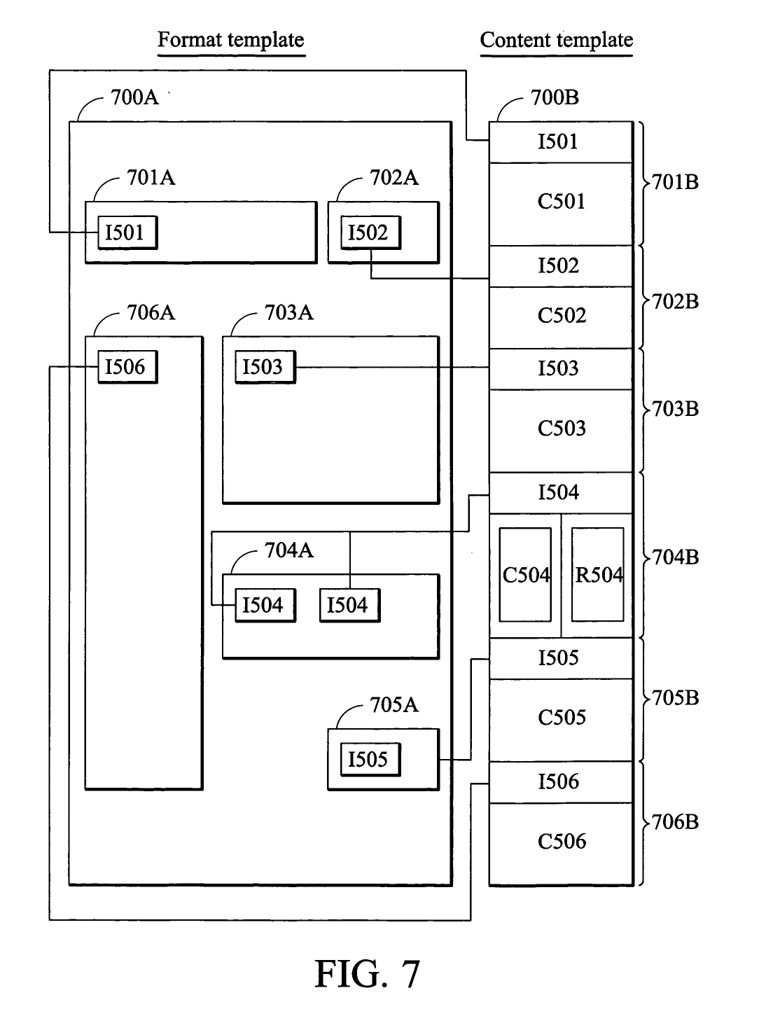

FIG. 8 is a schematic diagram of another exemplary web page layout; and

FIG. 9 is a schematic diagram of an exemplary storage medium.

### DETAILED DESCRIPTION

Embodiments of systems and methods for establishing education web page templates are provided. Some features of US PAT. Entitled “SYSTEM AND METHOD OF ONLINE EDUCATION WEBSITE ESTABLISHMENT” are incorporated. System 10 for establishing education web page templates can be implemented by computer programs or circuits.

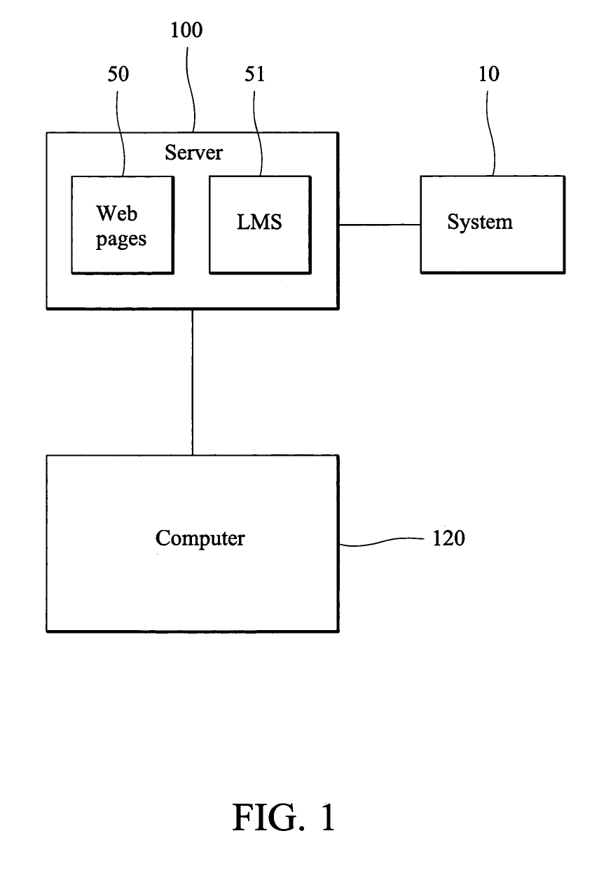

In FIG. 1, server 100 comprises a plurality of web pages 50 and a Learning Management System (LMS) 51. Server 100 is coupled to system 10 and client computer 120 through network. LMS 51 executes course related processes, manages and transmits course data, such as web pages 50, through the network, maintains personal learning data and/or monitors learning status. Computer 120 can be operated to download at least one web page 50 from server 100 and display the web page. Web pages 50 as course pages may comprise articles, pictures, multimedia teaching materials, examination data, and/or interfaces for receiving data from or transmitting data to LMS 51 (such as later-detailed control elements 112, quiz elements 113, and info elements 114).

System 10 can be implemented by a computer program executed in server 100 or a computer coupled thereto for establishing web pages 50 and providing web pages 50 to server 100.

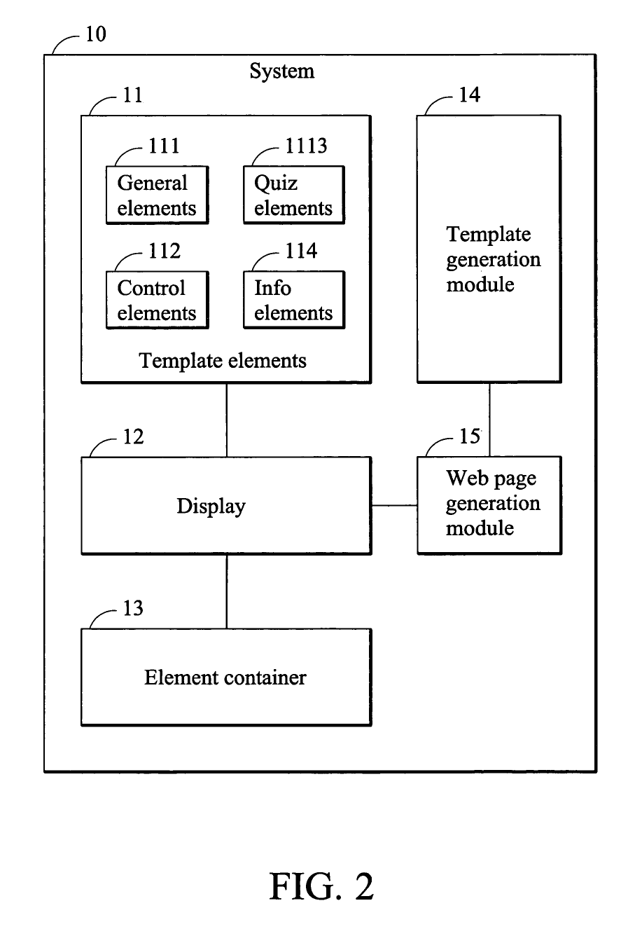

In FIG. 2, template elements 11 are coupled to display 12, element container 13, template generation module 14, and web page generation module 15. Template elements 11 comprise general elements 111, control elements 112, quiz elements 113, and info elements 114. Element container 13 which may comprise HTML, CSS, and JavaScript, accommodates backgrounds and template elements 11.

Each template element 11 comprises adjustable attributes including behavior attributes, appearance attributes, and design attributes. The behavior attributes comprise action script (such as JavaScript) settings, such as scripts for controlling animation of general elements 111, scripts of control elements 112 for transmitting data to LMS 51, scripts of info elements 114 for receiving data from LMS 51, and scripts of quiz elements 113 for grading score. The appearance attributes include position and dimensions of template elements 11 and can be adjusted by way of dragging. The design attributes comprise names, model names, field names, field description, and indices of template elements 11. A name and an index of a template element 11 form the identification (ID) string thereof. Names, field names, field description, and indices can be adjusted. Each template element 11 may comprise sub-elements with adjustable behavior, appearance, and design attributes.

General elements 111 may comprise HTML tags, CSS, and/or JavaScripts necessary for presenting course content. For example, page elements presented by general elements 111 may comprise titles, articles, pictures, multimedia, Flash files, and audio data. The titles indicate course subjects. The articles may include graphical text, such as formulas and chemical formulas. The pictures comprise essential academic graphs, such as flowcharts and schematic diagrams. The multimedia and audio data may be multimedia objects embedded in course pages, such as audio files of linguistic courses.

When a template element 11 is dragged to element container 13 and adjusted, a page element corresponding to the template element 11 is identified, and the region where the template element 11 is located is identified as the same region of the page element. Web page generation module 15 generates a web page, a page element and scripts therein according to attributes of the template element 11. The size and position of the generated page element reflects the adjusted size and position of the template element 11.

Page elements, such as “Submit” and “Finish” buttons, corresponding to control elements 112 transmit data to LMS 51 through standardized application program interface (API), such as Shareable Content Object Reference Model (SCORM). “Submit” buttons transmit answers of quiz elements 113 and learning-related data to LMS 51. “Finish” buttons transmit learning-related data to LMS 51, such as the learning time.

After one control element 112 is dragged to element container 13 and adjusted, a page element corresponding to the control element and necessary API routines and data models are identified, such as SCORM API routines and data models. Web page generation module 15 generates a web page and a page element, comprising instances of the routines and the data model according to attributes of the control element 112. The size and position of the generated page element reflects the adjusted size and position of the control element.

Page elements corresponding to quiz elements 113 comprise examination questions concerning course content, which can be presented after or before a course. “Submit” buttons of control elements 112 cooperating with quiz elements 113 may transmit answers thereof to LMS 51. The examination questions comprise True/False questions, multiple choice, and completion questions. Each question comprises a question number, question content, alternatives, answers, and a grading script.

After one quiz element 113 is dragged onto element container 13, adjusted, and configured, a page element corresponding to the quiz element, necessary API routines, such as grading scripts, and data models are identified. Web page generation module 15 generates a web page comprising a page element and instances of the routines and the data model according to attributes of the quiz element. The size and position of the generated page element reflects the adjusted size and position of the quiz element. The number of alternatives of the page element reflects the number of alternatives of the quiz element.

Page elements corresponding to info elements 114 receive data from LMS 51 and present the data on web pages. The page elements may comprise elements for displaying student ID numbers, student names, or login time of an on-line user accessing LMS 51.

After one of info elements 114 is dragged to element container 13, adjusted, and configured, a page element corresponding to the info element and necessary API routines and data models are identified. “cmi.core.student_id”, “cmi.core.student_name”, and “cmi.core.total_time” are examples of SCORM API data models, respectively displaying student ID numbers, student names, and login time. Web page generation module 15 generates a web page comprising a page element and instances of the routines and the data models according to attributes of the info element. The size and position of the generated page element reflects the adjusted size and position of the info element.

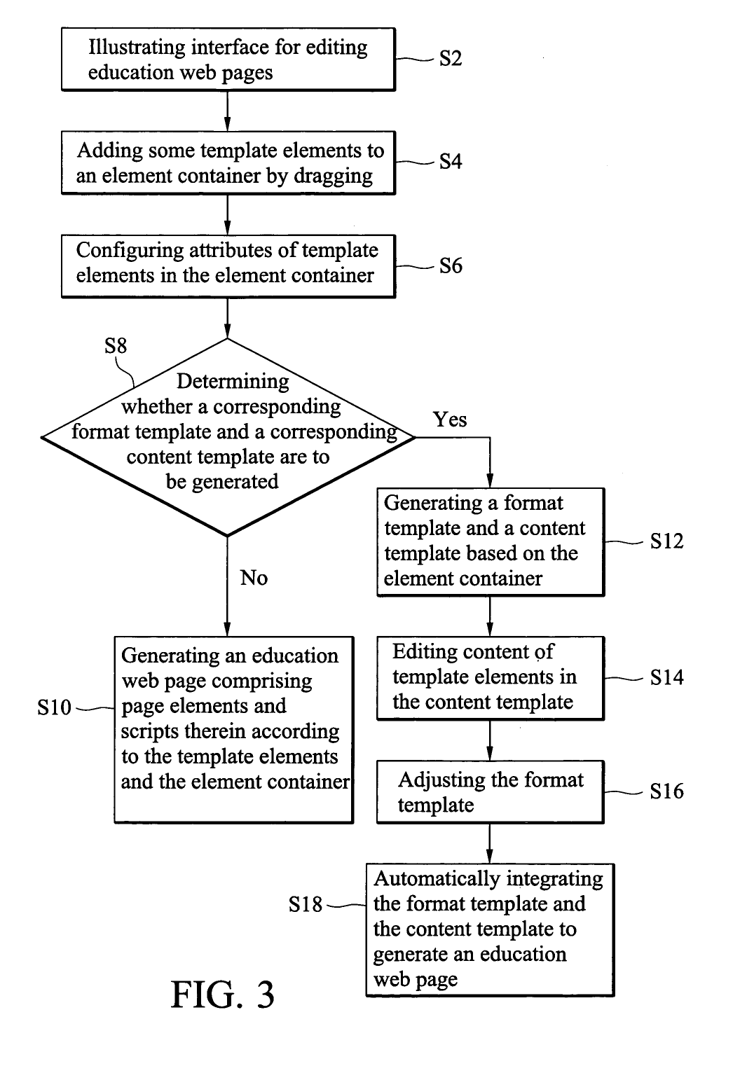

Description of web page template composition is given in the following with reference to FIG. 3.

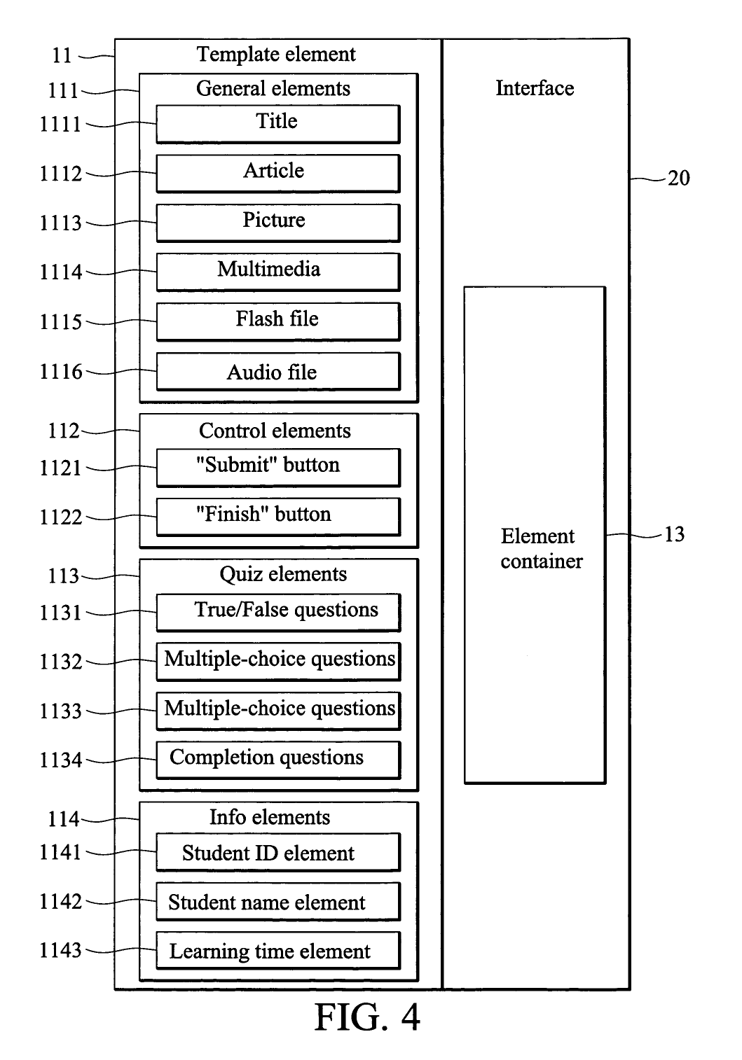

First, display 12 illustrates interface 20 comprising template elements 11 and element container 13 shown in FIG. 4 for editing education web pages (step S2). For example, the interface in FIG. 4 may be displayed by a computer display. Note that appearance of template elements 11 and element container 13 can be modified and is not limited to the exemplary configuration shown in FIG. 4. The displayed general elements 111 comprise title 1111, article 1112, picture 1113, multimedia 1114, and Flash file 1115, and audio file 1116. Control elements 112 comprise “Submit” button 1121 and “Finish” button 1122. The displayed quiz elements 113 comprise True/False questions 1131, multiple-choice 1132 where one choice is correct, multiple-choice questions 1133 where one or more choices are correct, and completion questions 1134. The displayed info elements 114 comprise student ID element 1141, student name element 1142, and learning time element 1143. Interface 20 may display portion or all of template elements 11 and Graphical User Interface (GUI) for configuring attributes thereof.

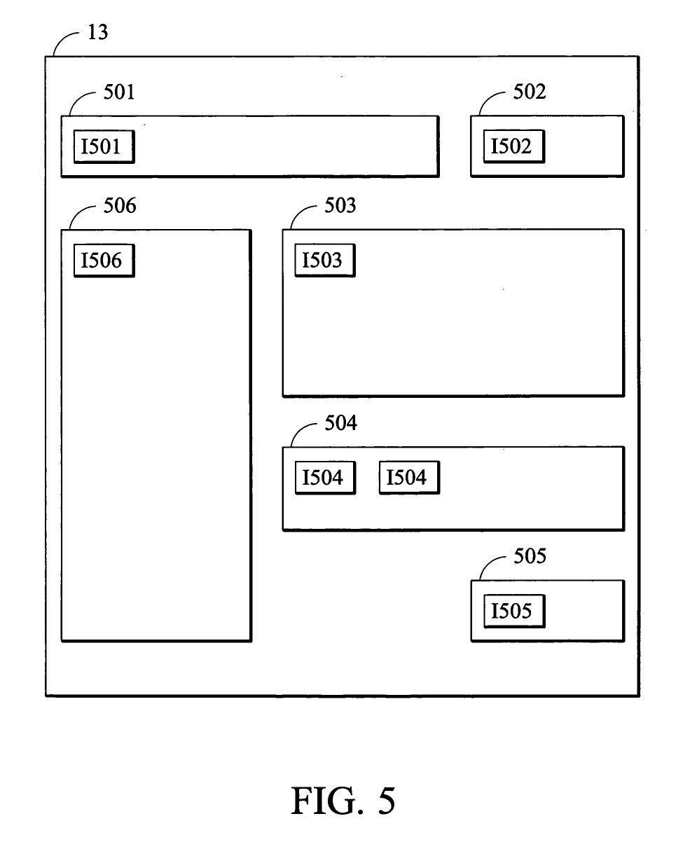

Some template elements 11 are added to element container 13 by dragging (step S4). FIG. 5 shows element container 13 and template elements 501˜506 therein. For example, template elements 501˜506 are respectively a title, a student ID element, a multimedia file, an examination question, a “Submit” button, and an article. Attributes of template elements 501˜506, such as ID strings I501˜I506, behavior and appearance attributes thereof, may be further configured (step S6). The behavior attributes comprise attributes of routines. For example, when template element 504 is a quiz element, the question type, grading scripts, and the number of alternatives of template element 504 can be configured in step S6, wherein attribute N504 corresponds to the number of the alternatives. Additionally, template elements 11 may comprise content attributes for configuring actual web page content. Content attributes of template elements 501˜506 may be composed in step S6 or after content elements corresponding to template elements 501˜506 are generated by template generation module 14.

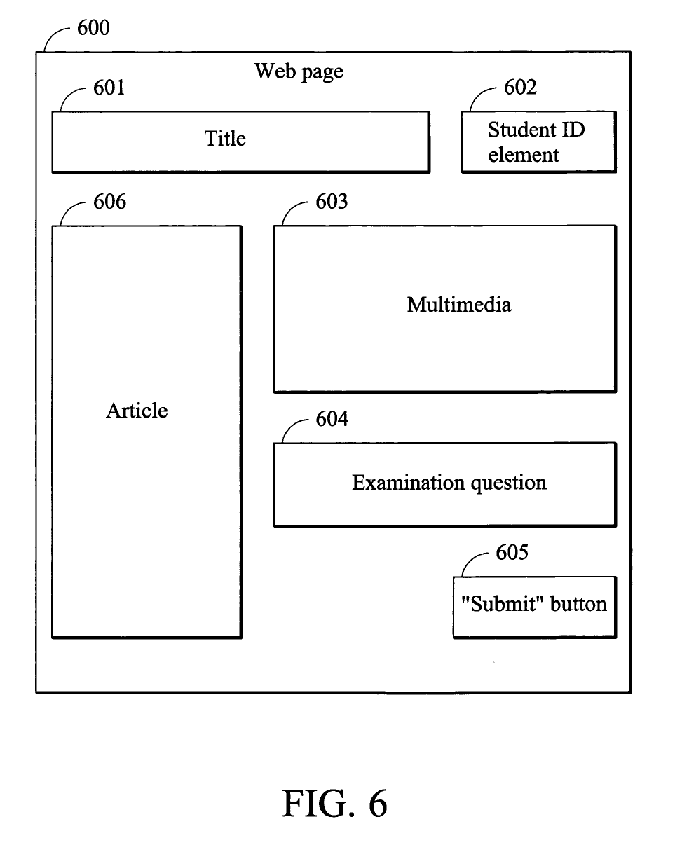

It is determined whether a corresponding format template and a corresponding content template are to be generated (step S8). If not, after attributes of template elements 501˜506 are configured, web page generation module 15 generates an education web page 600 comprising page elements and scripts therein according to template elements 501˜506 and element container 13, as shown in FIG. 6 (step S10). Interface 20 provides GUI elements for configuring content attributes of template elements 501˜506, such as question content, alternatives, correct answers, grade rules of template element 504.

Web page 600 which may comprise HTML, JavaScript, and/or SCORM API routines and data models comprises page elements 601˜606 corresponding to template elements 501˜506, including scripts of page element 604 and page elements for communication with LMS 51, such as page element 602 receiving student ID number of a logged user from LMS 51 and page element 605 transmitting response answers of page element 604 and learning data in web page 600 to LMS 51. The scripts of page element 604 grades a score based on the response answers, correct answers, and the grade rule.

If the corresponding format template and content template is to be generated, template generation module 14 generates format template 700A and content template 700B (step S12). Content template 700B may be a program readable data file, such as a Microsoft Word document. Format template 700A comprise format elements 701A˜706A respectively corresponding to template elements 501˜506. Content template 700B comprise content elements 701B˜706B respectively corresponding to template elements 501˜506. In FIG. 5, template elements 501˜506 respectively have ID numbers I501˜I506. Format elements 701A˜706A respectively have ID numbers I501˜I506, and content elements 701B˜706B respectively have ID numbers I501˜I506 and fields C501˜C506 for receiving content of template elements 501˜506. Thus, content of template elements 501˜506 can be edited in content template 700B (step S14). For example, field C501 may comprise a title; field C502 may comprise text, such as “Your ID”, in front of actual student ID number; field C503 may comprise a path of a multimedia file; field C504 may comprise question content and alternatives thereof; field R504 may comprise alternatives, wherein the number of field R504 may be adjusted based on attribute N504; field C505 may comprise text for GUI control elements 112 such as buttons; and field C506 may comprise text and pictures for general elements 111.

Format template 700A including format elements 701A˜706A and the background thereof may be further adjusted (step S16).

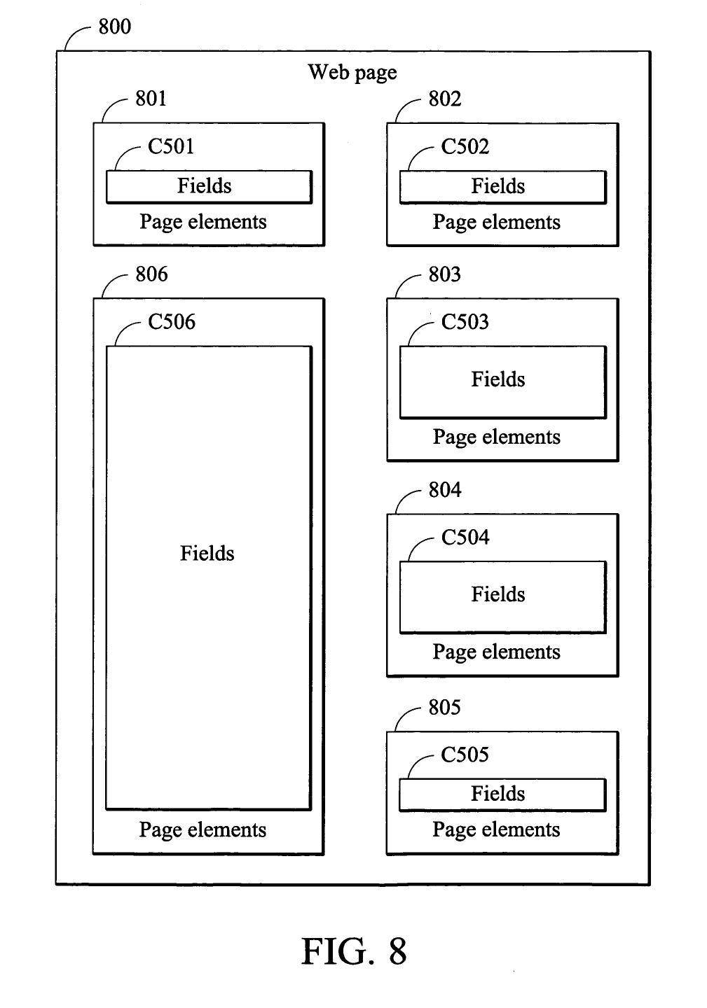

Web page generation module 15 automatically integrates format template 700A and content template 700B to generate an education web page 800, as shown in FIG. 8 (step S18). Web page 800 which may be composed of HTML tags, JavaScripts, and/or SCORM API routines and data model may comprise page elements 801˜806 generated by integrating format elements 701A˜706A and content elements 701B˜706B. Page elements 801˜806 respectively comprise content of field C501˜C502, the multimedia file linked by the link in field C503, and content of field C504-C506. Page element 802 may receive a student ID number of an on-line user from LMS 51. Scripts of page element 805 transmit learning data and student-given answers to LMS 51 and scripts of page element 804. The scripts of page element 804 grade a score based on the correct answer, the submitted answers, and the grade rule. The sizes and positions of page elements 801˜806 reflect the adjusted sizes and positions of format elements 701A˜706A. The sizes and positions of format elements 701A˜706A reflect the adjusted sizes and positions of template elements 501˜506.

Additionally, the methods for establishing education web page templates can be implemented in a computer application in a storage medium such as a memory or a memory device. The computer application, when loaded into a computer, directs the computer to execute the previously-described method.

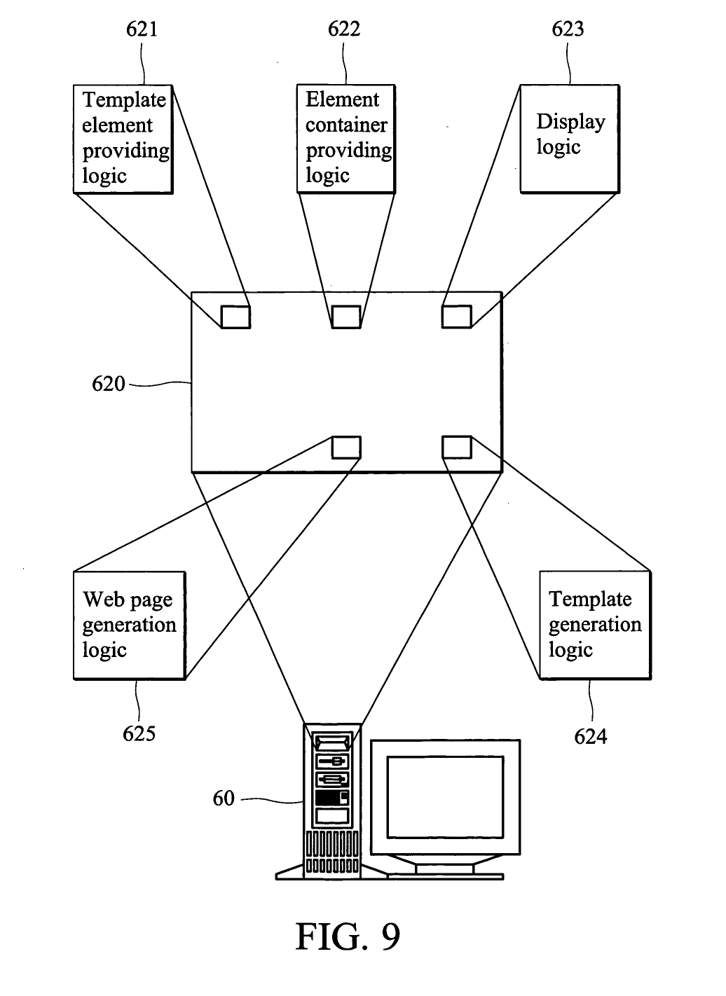

In FIG. 9, storage medium 60 stores a computer program 620 implementing the method for establishing education web page templates. The computer program 620 comprises template element providing logic 621, element container providing logic 622, display logic 623, template generation logic 624, and web page generation logic 625. Template element providing logic 621 presents template elements. Element container providing logic 622 provides element containers. Display logic 623 illustrates an editing interface. Template generation logic 624 generates format templates and content templates. Web page generation logic 625 generates web pages.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for establishing education web page templates, comprising:
an element container;
a plurality of template elements one of which is added to the element container by dragging; and
a template generation module creating a format template and a content template based on the element container and the template element therein, wherein the format template comprises a format element corresponding to the template element, the content template comprises a content element corresponding to the template element, and the format template and the content template are further integrated to generate a web page comprising a page element generated by integrating the format element and the content element.

2. The system as claimed in claim 1, wherein the template element comprises a general element.

3. The system as claimed in claim 1, wherein the template element comprises a control element.

4. The system as claimed in claim 1, wherein the template element comprises a quiz element.

5. The system as claimed in claim 1, wherein the template element comprises an info element.

6. The system as claimed in claim 1, wherein the web page element is generated utilizing the Shareable Content Object Reference Model (SCORM).

7. A system for establishing education web page templates, comprising:
an element container;
a plurality of template elements, wherein one of the template elements is added to the element container by dragging; and
a web page generation module creating a web page comprising a page element corresponding to the template element based on the element container and the template element therein, wherein the page element communicates with a Learning Management System (LMS).

8. The system as claimed in claim 7, wherein the template element comprises a control element transmitting data to the Learning Management System.

9. The system as claimed in claim 7, wherein the template element comprises a quiz element receiving an answer to an examination question thereof and transmitting the answer to the Learning Management System.

10. The system as claimed in claim 7, wherein the template element comprises an info element receiving data from the Learning Management System.

11. The system as claimed in claim 7, wherein the web page generation module generates the web page element utilizing the Shareable Content Object Reference Model (SCORM).

12. A method for establishing education web page templates, implemented in a computer comprising an element container, a plurality of template elements, and a template generation module, the method comprising:
displaying the template elements and the element container;
adding one template element to the element container by dragging; and
creating, by the template generation module, a format template and a content template based on the element container and the template element therein, wherein the format template comprises a format element corresponding to the template element, the content template comprises a content element corresponding to the template element, and the format template and the content template, by further integration, generate a web page comprising a page element generated by integrating the format element and the content element.

13. The method as claimed in claim 12, wherein the template element comprises a general element.

14. The method as claimed in claim 12, wherein the template element comprises a control element.

15. The method as claimed in claim 12, wherein the template element comprises a quiz element.

16. The method as claimed in claim 12, wherein the template element comprises an info element.

17. The method as claimed in claim 12, further comprising automatically generating the web page and the page element.

18. The method as claimed in claim 12, wherein the web page element is generated utilizing the Shareable Content Object Reference Model (SCORM).
